(19) United States
(12) Patent Application Publication
(10) Pub. No.: US 2026/0196864 A1
(43) Pub. Date: Jul. 9, 2026

(54) UNINTERRUPTIBLE POWER SUPPLY DEVICE

(71) Applicant: TMEIC Corporation, Tokyo (JP)

(72) Inventor: Ryogo IMANISHI, Chuo-ku (JP)

(73) Assignee: TMEIC Corporation, Tokyo (JP)

(21) Appl. No.: 19/128,421

(22) PCT Filed: Oct. 10, 2023
(86) PCT No.: PCT/JP2023/036698

§ 371 Date: May 8, 2025

(51) Int. Cl. H02J 9/06; H02J 7/90; H02J 7/96; H02M 1/088; H02M 3/158

(52) U.S. Cl. CPC H02J 9/062; H02J 7/933; H02J 7/96; H02M 1/088; H02M 3/158; H02J 2207/20

(57) ABSTRACT

An uninterruptible power supply device includes a converter, an inverter, a DC link connected between the converter and the inverter, and a bidirectional chopper that performs DC voltage conversion between the DC link and a power storage device. The bidirectional chopper performs a charging operation of storing the DC power of the DC link in the power storage device during normal operation of an AC power supply. When a charge termination voltage of the power storage device is higher than a DC link voltage of the DC link and a discharge termination voltage of the power storage device is lower than the DC link voltage, the bidirectional chopper performs, when performing the charging operation, a first step-down operation of stepping down the DC link voltage and a first step-up operation of stepping up the DC link voltage while switching therebetween in accordance with a voltage of the power storage device.

### TECHNICAL FIELD

The present disclosure relates to an uninterruptible power supply device.

### BACKGROUND ART

For example, WO 2021/130981 (PTL 1) discloses an uninterruptible power supply device including a power converter connected between an alternate-current (AC) power supply and a load. The power converter includes a converter that converts AC power supplied from the AC power supply into direct-current (DC) power and outputs the DC power to a DC link, an inverter that converts the DC power received from the DC link into AC power and supplies the AC power to the load, and a bidirectional chopper that exchanges DC power between the DC link and a power storage device.

In this uninterruptible power supply device, the power storage device is used as a power storage device that stores DC power to be used during a power failure of the AC power supply. The bidirectional chopper is controlled such that the power storage device is charged during normal operation of the AC power supply and the power storage device is discharged during a power failure of the AC power supply.

### CITATION LIST

### Patent Literature

PTL 1: WO 2021/130981

### SUMMARY OF INVENTION

### Technical Problem

Most conventional uninterruptible power supply devices include lead-acid batteries for the power storage device. In the conventional uninterruptible power supply device, a DC link voltage input to the inverter is made high such that the output voltage of the inverter becomes the AC output voltage of the uninterruptible power supply device as it is, while, in order to reduce the number of lead-acid batteries used as much as possible to miniaturize the power storage device, a power storage device having a lower operating voltage range than the DC link voltage is used. Thus, the bidirectional chopper is configured to step down the DC link voltage and output the DC link voltage to the power storage device when charging the power storage device, and to step up the voltage of the power storage device and output the voltage to the DC link when discharging the power storage device.

In recent years, lithium-ion batteries have been increasingly used in a variety of products, such as mobile devices, electric vehicles, and industrial robots. The lithium-ion batteries have many advantages over lead-acid batteries, such as i) high energy density, which allows reductions in size and weight, ii) high voltage and high current, which lead to a reduction in the number of batteries used, iii) long life, iv) fast chargeability, and v) wide operating environmental temperature range.

The use of lithium-ion batteries for the power storage device of an uninterruptible power supply device can expand the operating voltage range of the power storage device while reducing the size of the power storage device. In addition, the use of lithium-ion batteries for the power storage device provides advantages such as long life, fast chargeability, and a wide operating environmental temperature range. On the other hand, in the uninterruptible power supply device, the upper limit of the operating voltage range of the power storage device may be higher than the DC link voltage. In order to cope with such cases, it is necessary to improve the bidirectional chopper.

The present disclosure has been made to solve the above problem. An object of the present disclosure is to provide an uninterruptible power supply device that can work with an energy storage device having a wide operating voltage range.

### Solution to Problem

An uninterruptible power supply device according to an aspect of the present disclosure is connected between an AC power supply and a load. The uninterruptible power supply device includes a converter that converts AC power supplied from the AC power supply into DC power, an inverter that converts the DC power into AC power and supplies the AC power to the load, a DC link connected between the converter and the inverter for inputting the DC power to the inverter, and a bidirectional chopper that performs DC voltage conversion between the DC link and a power storage device. The bidirectional chopper is configured to perform a charging operation of storing the DC power of the DC link in the power storage device during normal operation of the AC power supply. When a charge termination voltage of the power storage device is higher than a DC link voltage of the DC link and a discharge termination voltage of the power storage device is lower than the DC link voltage, the bidirectional chopper performs, when performing the charging operation, a first step-down operation of stepping down the DC link voltage and a first step-up operation of stepping up the DC link voltage while switching therebetween in accordance with a voltage of the power storage device.

### Advantageous Effects of Invention

According to the present disclosure, an uninterruptible power supply device can be provided that can work with an energy storage device having a wide operating voltage range.

### BRIEF DESCRIPTION OF DRAWINGS

FIG. 1 is a circuit block diagram showing a configuration of an uninterruptible power supply device according to Embodiment 1.

FIG. 2 is a block diagram showing an example hardware configuration of a controller.

FIG. 3 illustrates an operation of the uninterruptible power supply device during normal operation of the AC power supply.

FIG. 4A illustrates an operation of charging a batter by a bidirectional chopper.

FIG. 4B illustrates the operation of charging the battery by the bidirectional chopper.

FIG. 5 illustrates an operation of the uninterruptible power supply device during a power failure of the AC power supply.

FIG. 6A illustrates an operation of discharging the battery by the bidirectional chopper.

FIG. 6B illustrates the operation of discharging the battery by the bidirectional chopper.

FIG. 7 is a flowchart for illustrating control of the bidirectional chopper by the controller.

FIG. 8 is a circuit diagram showing a first configuration example of the bidirectional chopper.

FIG. 9 illustrates an operation of the bidirectional chopper according to the first configuration example.

FIG. 10 is a circuit diagram showing a second configuration example of the bidirectional chopper.

FIG. 11 illustrates an operation of the bidirectional chopper according to the second configuration example.

FIG. 12 is a circuit diagram showing a third configuration example of the bidirectional chopper.

FIG. 13 illustrates an operation of the bidirectional chopper according to the third configuration example.

FIG. 14 is a circuit block diagram showing a configuration of an uninterruptible power supply device according to Embodiment 2.

### DESCRIPTION OF EMBODIMENTS

Embodiments of the present disclosure will be described in detail with reference to the drawings. The same or corresponding parts in the figures have the same reference characters allotted, and description thereof will not be repeated.

### Embodiment 1

### <Configuration of Uninterruptible Power Supply Device>

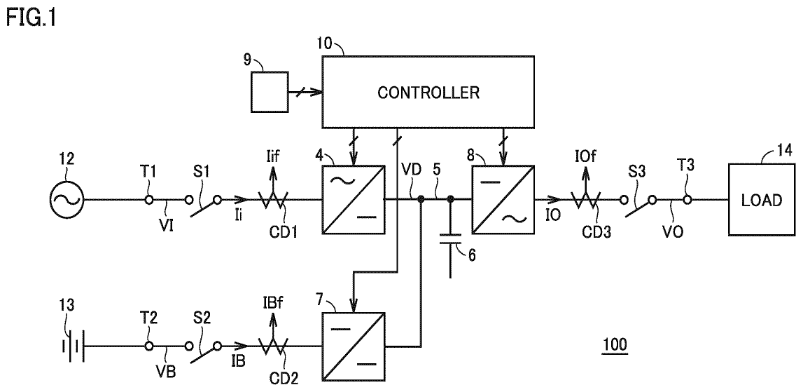

FIG. 1 is a circuit block diagram showing a configuration of an uninterruptible power supply device according to Embodiment 1. As shown in FIG. 1, an uninterruptible power supply device 100 is connected between an AC power supply 12 and a load 14. Uninterruptible power supply device 100 receives a three-phase AC voltage from AC power supply 12 and supplies the three-phase AC voltage to load 14, but for simplicity of the drawing and description, only the circuit for one phase is shown in FIG. 1.

Uninterruptible power supply device 100 includes an input terminal T1, a DC terminal T2, an output terminal T3, switches S1 to S3, a converter 4, current detectors CD1 to CD3, a DC link 5, a capacitor 6, an inverter 8, an operation unit 9, and a controller 10.

Input terminal T1 receives AC power of a predetermined frequency (e.g., commercial frequency) from AC power supply 12. AC power supply 12 can be a commercial AC power supply or a generator. An instantaneous value of an AC input voltage V1 is detected by controller 10. Based on the instantaneous value of AC input voltage V1, the presence or absence of a power failure or the like is determined. Current detector CD1 detects an AC input current Ii flowing to input terminal T1 and provides a signal Iif, which indicates a value of the detection, to controller 10.

Output terminal T3 is connected to load 14. Load 14 is driven by AC power of a predetermined frequency (e.g., commercial frequency) supplied from uninterruptible power supply device 100.

DC terminal T2 is connected to a battery 13. Battery 13 constitutes an “energy storage device” that stores DC power. However, a capacitor may be connected instead of battery 13. An instantaneous value of a voltage VB between the terminals of battery 13 is detected by controller 10. In the following description, voltage VB between the terminals of battery 13 is also referred to as “battery voltage VB”.

Switch S1 is connected between input terminal T1 and an AC node of converter 4 and is controlled by controller 10. When AC power is normally supplied from AC power supply 12 (during normal operation of AC power supply 12), switch S1 is turned on to supply AC power from AC power supply 12 to converter 4 through switch S1. When AC power is not normally supplied from AC power supply 12 (during a power failure of AC power supply 12), switch S1 is turned off to disconnect AC power supply 12 from converter 4.

Converter 4 is controlled by controller 10 to convert the AC power from AC power supply 12 into DC power and output the DC power to DC link 5 during normal operation of AC power supply 12. Converter 4 is a well-known one including a plurality of sets of semiconductor switching elements and diodes.

Capacitor 6 is connected to DC link 5, and smooths and stabilizes a DC link voltage VD. An instantaneous value of DC voltage VD of DC link 5 is detected by controller 10. In the following description, DC voltage VD of DC link 5 is also referred to as “DC link voltage VD”.

During normal operation of AC power supply 12, controller 10 controls converter 4 such that DC link voltage VD becomes equal to a reference DC voltage VDR. During a power failure of AC power supply 12, controller 10 stops the operation of converter 4.

DC link 5 is connected to DC terminal T2 via a bidirectional chopper 7 and switch S2. Switch S2 is controlled by controller 10. Switch S2 is turned on when uninterruptible power supply device 100 is used. Switch S2 is turned off during maintenance of battery 13 and bidirectional chopper 7.

Bidirectional chopper 7 is controlled by controller 10 to perform DC voltage conversion between DC link 5 and battery 13, thereby exchanging DC power between DC link 5 and battery 13. Bidirectional chopper 7 is configured to selectively perform a charging operation of storing the DC power of DC link 5 in battery 13 and a discharging operation of supplying the DC power stored in battery 13 to DC link 5. Current detector CD2 detects a DC current IB, which flows between battery 13 and bidirectional chopper 7, and provides a signal IBf, which indicates a value of the detection, to controller 10.

During normal operation of AC power supply 12, controller 10 controls bidirectional chopper 7 such that battery voltage VB becomes equal to a reference DC voltage VBR. During a power failure of AC power supply 12, controller 10 controls bidirectional chopper 7 such that DC link voltage VD becomes equal to reference DC voltage VDR. Bidirectional chopper 7 will be described later in detail.

DC link 5 is connected to a DC node of inverter 8, and an AC node of inverter 8 is connected to output terminal T3 via switch S3. Switch S3 is controlled by controller 10. Switch S3 is turned on when uninterruptible power supply device 100 is used. Switch S3 is turned off during maintenance of inverter 8.

Current detector CD3 detects an AC output current IO of inverter 8 and provides a signal IOf, which indicates a value of the detection, to controller 10. An instantaneous value of AC output voltage VO applied to load 14 is detected by controller 10.

Inverter 8 is controlled by controller 10 to convert the DC power supplied from converter 4 and bidirectional chopper 7 through DC link 5 into AC power of a predetermined frequency (e.g., commercial frequency) and supply the AC power to load 14. Inverter 8 is a well-known one including a plurality of sets of semiconductor switching elements and diodes.

Operation unit 9 includes a plurality of buttons, a plurality of switches, and an image display. The user of uninterruptible power supply device 100 can operate operation unit 9 to turn on and off uninterruptible power supply device 100 and automatically or manually operate uninterruptible power supply device 100. Operation unit 9 outputs a signal and information indicating what has been operated by the user to controller 10.

Controller 10 controls switches S1 to S3, converter 4, bidirectional chopper 7, and inverter 8 based on the signal from operation unit 9, AC input voltage V1, AC output voltage VO, DC link voltage VD, battery voltage VB, AC input current Ii, DC current IB, and AC output current IO.

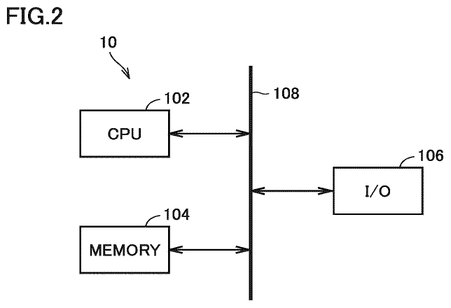

FIG. 2 is a block diagram showing an example hardware configuration of controller 10. Typically, controller 10 can be constituted of a microcomputer with a predetermined program stored in advance.

In the example of FIG. 2, controller 10 includes a central processing unit (CPU) 102, a memory 104, and an input/output (I/O) circuit 106. CPU 102, memory 104, and I/O circuit 106 can exchange data with one another via a bus 108. Memory 104 has a partial area with a program stored, and various functions, which will be described later, can be implemented as CPU 102 executes the program. I/O circuit 106 inputs and outputs signals and data to and from the outside of controller 10.

Alternatively, unlike the example of FIG. 2, at least part of controller 10 can be configured with a circuit such as a field programmable gate array (FPGA) or an application specific integrated circuit (ASIC). Also, at least part of controller 10 can be configured with an analog circuit.

In uninterruptible power supply device 100 shown in FIG. 1, for example, lithium-ion batteries are used for battery 13. The lithium-ion batteries have many advantages over lead-acid batteries, such as i) high energy density, which allows reductions in size and weight, ii) high voltage and high current, which lead to a reduction in the number of batteries used, iii) long life, iv) fast chargeability, and v) wide operating environmental temperature range. In recent years, thus, the lithium-ion batteries have been increasingly used in a variety of products, such as mobile devices, electric vehicles, and industrial robots.

An operating voltage range is set for battery 13. In this specification, the lower limit of the operating voltage range is referred to as a “discharge termination voltage V1”, and the upper limit of the operating voltage range is referred to as a “charge termination voltage V2”. Discharge termination voltage V1 is the lower limit of the discharge voltage at which discharging can be performed safely. Discharge termination voltage V2 is the upper limit of the charge voltage at which charging can be performed safely. The state in which discharging has been performed to a voltage below discharge termination voltage V1 is referred to as “overdischarge”, and the state in which charging has been performed to a voltage above charge termination voltage V2 is referred to as “overcharge”, both of which cause performance deterioration of battery 13.

It is assumed in the present embodiment that the relationship V1<VD<V2 is established among discharge termination voltage V1, charge termination voltage V2, and DC link voltage VD. In other words, charge termination voltage V2 is higher than DC link voltage VD, and discharge termination voltage V1 is lower than DC link voltage VD.

The following configuration is adopted in a conventional uninterruptible power supply device including lead-acid batteries: DC link voltage VD input to inverter 8 is made high such that the output voltage of inverter 8 becomes the AC output voltage of the uninterruptible power supply device as it is, while, in order to reduce the number of lead-acid batteries used as much as possible to miniaturize battery 13, a step-up/down chopper is inserted between DC link 5 and battery 13, and battery voltage VB is stepped up when battery 13 is discharged and DC link voltage VD is stepped down when battery 13 is charged. In this configuration, the relationship V1<V2<VD is established between battery voltage VB and DC link voltage VD. In other words, discharge termination voltage V1 and charge termination voltage V2 are lower than DC link voltage VD.

The use of lithium-ion batteries for battery 13 of uninterruptible power supply device 100 can expand the operating voltage range of battery 13 compared with the conventional uninterruptible power supply device while satisfying the requirement for miniaturization of battery 13. Thus, a battery having charge termination voltage V2 higher than DC link voltage VD can be used for battery 13, as in the present embodiment. In addition, the use of lithium-ion batteries for battery 13 can achieve the advantages such as long life, fast chargeability, and a wide operating environmental temperature range.

### <Operation of Uninterruptible Power Supply Device>

Next, an operation of uninterruptible power supply device 100 according to Embodiment 1 will be described.

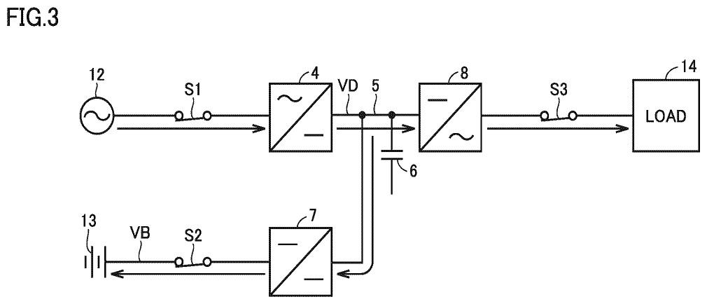

FIG. 3 illustrates the operation of uninterruptible power supply device 100 when AC power supply 12 is normal. The arrows in the figure show a flow of electric power exchanged among AC power supply 12, load 14, and battery 13.

As shown in FIG. 3, converter 4 converts AC power supplied from AC power supply 12 into DC power and outputs the DC power to DC link 5. Inverter 8 converts the DC power input from DC link 5 into AC power and supplies the AC power to load 14.

Bidirectional chopper 7 stores the DC power supplied from converter 4 through DC link 5 in battery 13. Controller 10 controls bidirectional chopper 7 such that battery voltage VB becomes equal to reference DC voltage VBR. Reference DC voltage VBR is set to charge termination voltage V2 of battery 13. When battery voltage VB rises and reaches charge termination voltage V2, controller 10 stops charging of battery 13 by stopping bidirectional chopper 7.

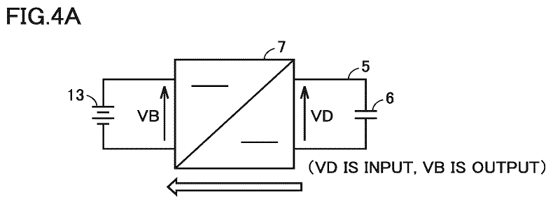

FIGS. 4A and 4B illustrate a charging operation of battery 13 by bidirectional chopper 7. FIG. 4A shows how DC power is transmitted from DC link 5 to battery 13 by bidirectional chopper 7. In this case, the input voltage of bidirectional chopper 7 becomes equal to DC link voltage VD, and the output voltage of bidirectional chopper 7 becomes equal to battery voltage VB.

FIG. 4B shows an example time change of battery voltage VB during the charging operation. In the example of FIG. 4B, battery voltage VB is equal to discharge termination voltage V1 at a time t1, at which charging of battery 13 is started. As charging proceeds, battery voltage VB gradually increases from V1. Then, in response to battery voltage VB reaching charge termination voltage V2 at a time t3, charging of battery 13 is stopped.

Herein, there is the relationship V1<VD<V2 among discharge termination voltage V1, charge termination voltage V2, and DC link voltage VD. Thus, when charging battery 13, bidirectional chopper 7 performs a step-down operation of stepping down DC link voltage VD, which is the input voltage, and a step-up operation of stepping up DC link voltage VD while switching therebetween according to battery voltage VB.

Specifically, during the period in which battery voltage VB is lower than DC link voltage VD (the period from times t1 to t2), bidirectional chopper 7 performs the step-down operation. During the period in which battery voltage VB is higher than DC link voltage VD (the period from times t2 to time t3), bidirectional chopper 7 performs the step-up operation.

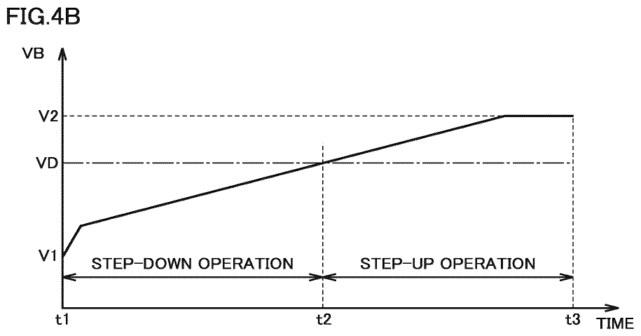

FIG. 5 illustrates an operation of uninterruptible power supply device 100 during a power failure of AC power supply 12. The arrows in the figure show a flow of electric power exchanged among AC power supply 12, load 14, and battery 13. When a power failure of AC power supply 12 occurs, switch S1 provided between input terminal T1 and the AC terminal of converter 4 is turned off, thereby disconnecting AC power supply 12 from uninterruptible power supply device 100. The operation of converter 4 is stopped.

Bidirectional chopper 7 supplies DC power of battery 13 to DC link 5. Inverter 8 converts the DC power input from DC link 5 into AC power and supplies the AC power to load 14. Controller 10 controls bidirectional chopper 7 such that DC link voltage VD becomes equal to reference DC voltage VDR. When battery voltage VB falls due to discharging of battery 13 and reaches discharge termination voltage V1, controller 10 stops discharging of battery 13 by stopping bidirectional chopper 7.

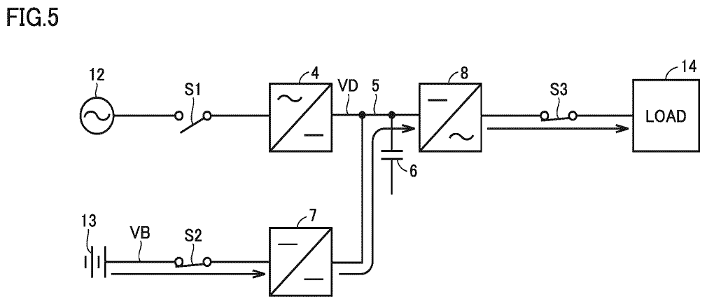

FIGS. 6A and 6B illustrate the discharging operation of battery 13 by bidirectional chopper 7. FIG. 6A shows how DC power is transmitted from battery 13 to DC link 5 by bidirectional chopper 7. In this case, the input voltage of bidirectional chopper 7 becomes equal to battery voltage VB, and the output voltage of bidirectional chopper 7 becomes equal to DC link voltage VD.

FIG. 6B shows an example time change of battery voltage VB during the discharging operation. In the example of FIG. 6B, battery voltage VB is equal to charge termination voltage V2 at a time t4, at which discharging of battery 13 is started. As discharging proceeds, battery voltage VB gradually decreases from V2. Then, in response to battery voltage VB reaching discharge termination voltage V1 at a time t6, discharging of battery 13 is stopped.

During the discharging operation, bidirectional chopper 7 performs the step-down operation of stepping down battery voltage VB, which is the input voltage, and the step-up operation of stepping up battery voltage VB while switching therebetween according to battery voltage VB. Specifically, during the period in which battery voltage VB is higher than DC link voltage VD (the period from times t4 to t5), bidirectional chopper 7 performs the step-down operation. During the period in which battery voltage VB is lower than DC link voltage VD (the period from times t5 to t6), bidirectional chopper 7 performs the step-up operation.

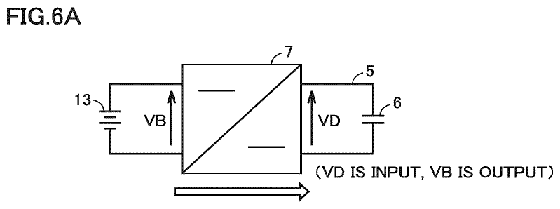

FIG. 7 is a flowchart for illustrating control of bidirectional chopper 7 by controller 10. The flowchart of FIG. 7 is repeatedly performed by controller 10 during operation of uninterruptible power supply device 100.

As shown in FIG. 7, in step (hereinafter simply referred to as “S”) 01, controller 10 determines whether a power failure of AC power supply 12 has occurred based on a detected value of AC input voltage V1. Determination is NO in S01 when AC input voltage V1 is within the normal range, and determination is YES in S01 when AC input voltage V1 is lower than the normal range.

When AC power supply 12 is normal (when determination is NO in S01), controller 10 moves to S02 and controls bidirectional chopper 7 to store the DC power of DC link 5 in battery 13 (see FIG. 3).

During charging of battery 13, in S03, controller 10 compares battery voltage VB with DC link voltage VD. When VB<VD (when determination is YES in S03), in S04, controller 10 controls bidirectional chopper 7 to step down DC link voltage VD and output DC link voltage VD to battery 13. When VB>VD (when determination is NO in S03), in S05, controller 10 controls bidirectional chopper 7 to step up DC link voltage VD and output DC link voltage VD to battery 13.

Returning to S01, when a power failure of AC power supply 12 has occurred (when determination is YES in S01), controller 10 moves to S06 and controls bidirectional chopper 7 to supply the DC power of battery 13 to DC link 5 (see FIG. 5).

During discharging of battery 13, in S07, controller 10 compares battery voltage VB with DC link voltage VD. When VB>VD (when determination is YES in S07), in S08, controller 10 controls bidirectional chopper 7 to step down battery voltage VB and output battery voltage VB to DC link 5. When VB<VD (when determination is NO in S07), in S09, controller 10 controls bidirectional chopper 7 to step up battery voltage VB and output battery voltage VB to DC link 5.

As described above, when charging battery 13, bidirectional chopper 7 performs step-down and step-up of DC link voltage VD while switching therebetween according to battery voltage VB. When discharging battery 13, bidirectional chopper 7 performs step-down and step-up of battery voltage VB while switching therebetween according to battery voltage VB. This allows charging and discharging of battery 13 whose charge termination voltage V2 is higher than DC link voltage VD.

### Configuration Example of Bidirectional Chopper

Next, a configuration example of bidirectional chopper 7 shown in FIG. 1 will be described.

### First Configuration Example

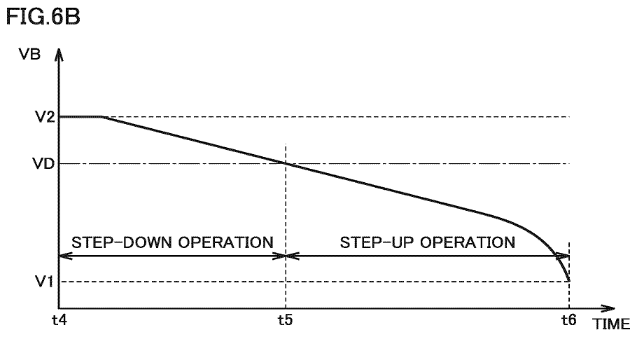

FIG. 8 is a circuit diagram showing a first configuration example of bidirectional chopper 7. Only DC link 5 on the positive side is shown in FIG. 1, but a DC link 5n on the negative side is also shown in FIG. 8.

As shown in FIG. 8, bidirectional chopper 7 according to the first configuration example includes a pair of DC terminals T11, T12, a pair of DC terminals T13, T14, semiconductor switching elements (hereinafter, also simply referred to as “switching elements”) Q1, Q2, diodes D1, D2, capacitors C1 to C3, and reactors L1, L2. In FIG. 8, insulated gate bipolar transistors (IGBTs) are used as switching elements Q1, Q2, but any semiconductor elements such as metal oxide semiconductor field effect transistors (MOSFETs) can be used.

The pair of DC terminals T11, T12 are connected to battery 13. DC terminal T11 on the positive side is connected to the positive electrode of battery 13, and DC terminal T12 on the negative side is connected to the negative electrode of battery 13. The pair of DC terminals T13, T14 are connected to DC links 5, 5n. DC terminal T13 on the positive side is connected to DC link 5 on the positive side, and DC terminal T14 on the negative side is connected to DC link 5n on the negative side.

Switching element Q1 has a collector connected to DC terminal T11 on the positive side and an emitter connected to a first terminal of capacitor C2. Capacitor C2A has a second terminal connected to a first terminal of reactor L2. Reactor L2 has a second terminal connected to DC terminal T13 on the positive side. Switching element Q1 corresponds to an embodiment of the “first switching element”.

Capacitor C1 is connected between DC terminal T11 on the positive side and DC terminal T12 on the negative side. Reactor L1 has a first terminal connected to the emitter of switching element Q1 and a first terminal of capacitor C1, and a second terminal of reactor L1 is connected to DC terminals T12, T14 on the negative side.

Switching element Q2 has a collector connected to the second terminal of capacitor C2 and the first terminal of reactor L2, and an emitter connected to DC terminals T12, T14 on the negative side. Capacitor C3 is connected between DC terminal T13 on the positive side and DC terminal T14 on the negative side. Switching element Q2 corresponds to an embodiment of the “second switching element”.

Diodes D1, D2 are connected in anti-parallel to switching elements Q1 and Q2, respectively. Diodes D1, D2 are provided to flow a return current (freewheel current) when the corresponding switching element Q is turned off. When switching element Q is a MOSFET, diodes D1, D2 may be constituted of parasitic diodes (body diodes).

When charging battery 13, bidirectional chopper 7 according to the first configuration example performs step-down and step-up of DC link voltage VD applied between the pair of DC terminals T13, T14 while switching therebetween according to battery voltage VB. At this time, bidirectional chopper 7 causes switching element Q2 to perform the switching operation and fixes switching element Q1 in the OFF state. When the current flow rate of switching element Q2 is α2, the relationship of the following Equation (1) is established between DC link voltage VD, which is the input voltage of bidirectional chopper 7, and battery voltage VB, which is the output voltage of bidirectional chopper 7. The current flow rate is the ratio of the time in which the switching element is in the ON state to the switching cycle of the switching element. As indicated by Equation (1), DC link voltage VD is stepped down when α2<0.5, and DC link voltage VD is stepped up when α2>0.5.

$$VB = VD \times α 2 / ( 1 - α 2 ) \qquad ( 1 )$$

When discharging battery 13, bidirectional chopper 7 according to the first configuration example performs step-down and step-up of battery voltage VB applied between the pair of DC terminals T11, T12 while switching therebetween according to battery voltage VB. At this time, bidirectional chopper 7 causes switching element Q1 to perform the switching operation and fixes switching element Q2 in the OFF state. When the current flow rate of switching element Q1 is α1, the relationship of the following Equation (2) is established between battery voltage VB, which is the input voltage of bidirectional chopper 7, and DC link voltage VD, which is the output voltage of bidirectional chopper 7. As indicated by Equation (2), battery voltage VB is stepped down when α1<0.5, and battery voltage VB is stepped up when α1>0.5.

$$VD = VB \times α 1 / ( 1 - α 1 ) \qquad ( 2 )$$

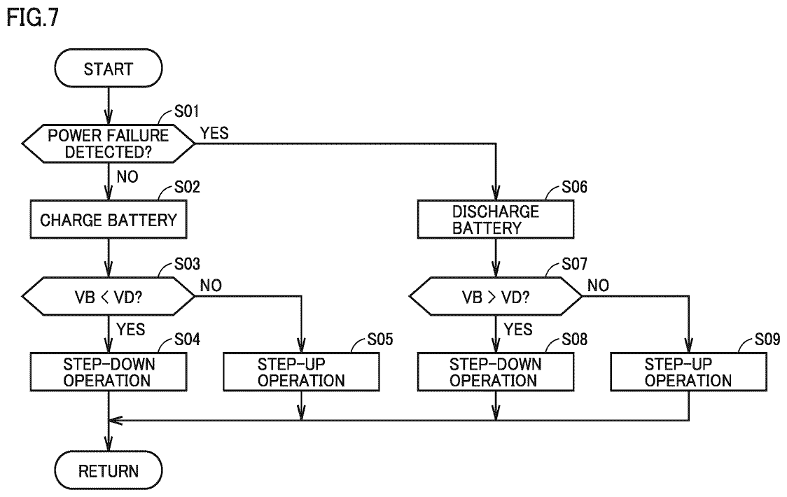

FIG. 9 illustrates an operation of bidirectional chopper 7 according to the first configuration example. As shown in FIG. 9, step-down and step-up of DC link voltage VD can be switched according to current flow rate α2 of switching element Q2. Step-down and step-up of DC link voltage VD can be switched according to current flow rate α1 of switching element Q1.

During normal operation of AC power supply 12, when VB<VD, controller 10 sets such that current flow rate α2 of switching element Q2<0.5, thereby controlling bidirectional chopper 7 to step down DC link voltage VD and output DC link voltage VD to battery 13 (first step-down operation). When VB>VD, controller 10 sets such that α2>0.5, thereby controlling bidirectional chopper 7 to step up DC link voltage VD and output DC link voltage VD to battery 13 (first step-up operation).

During a power failure of AC power supply 12, when VB>VD, controller 10 sets such that current flow rate α1 of switching element Q1<0.5, thereby controlling bidirectional chopper 7 to step down battery voltage VB and output battery voltage VB to DC link 5 (second step-down operation). When VB<VD, controller 10 sets such that α1>0.5, thereby controlling bidirectional chopper 7 to step up battery voltage VB and output battery voltage VB to DC link 5 (second step-up operation).

### Second Configuration Example

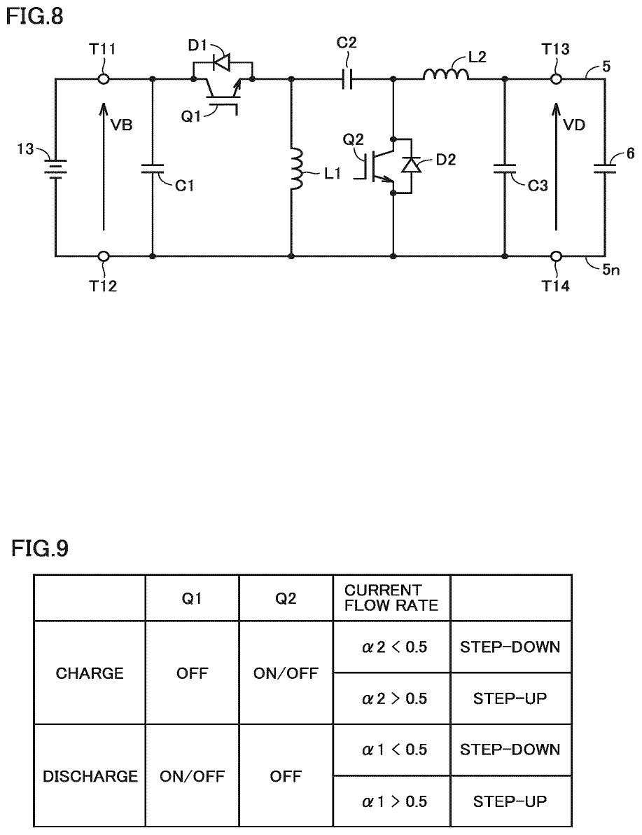

FIG. 10 is a circuit diagram showing a second configuration example of bidirectional chopper 7. As shown in FIG. 10, bidirectional chopper 7 according to the second configuration example includes the pair of DC terminals T11, T12, the pair of DC terminals T13, T14, switching elements Q1, Q2, diodes D1, D2, capacitors C1, C2, and reactor L1. IGBTs are used as switching elements Q1, Q2 in FIG. 10, but any semiconductor elements such as MOSFETs can be used.

The pair of DC terminals T11, T12 are connected to battery 13. DC terminal T11 on the positive side is connected to the positive electrode of battery 13, and DC terminal T12 on the negative side is connected to the negative electrode of battery 13. The pair of DC terminals T13, T14 are connected to DC links 5, 5n. DC terminal T14 on the negative side is connected to DC link 5n on the negative side, and DC terminal T13 on the positive side is connected to DC link 5 on the positive side. In the second configuration example, the polarities of the input voltage and the output voltage are reversed.

The collector of switching element Q1 is connected to DC terminal T11 on the positive side, and the emitter of switching element Q1 is connected to the collector of switching element Q2. The emitter of switching element Q2 is connected to DC terminal T14 on the negative side. Diodes D1, D2 are connected in anti-parallel to switching elements Q1 and Q2, respectively.

Capacitor C1 is connected between DC terminal T11 on the positive side and DC terminal T12 on the negative side. The first terminal of reactor L1 is connected to the emitter of switching element Q1 and the collector of switching element Q2, and the second terminal of reactor L1 is connected to DC terminal T12 on the negative side and DC terminal T13 on the positive side. Capacitor C2 is connected between DC terminal T13 on the positive side and DC terminal T14 on the negative side.

When charging battery 13, bidirectional chopper 7 according to the second configuration example performs step-down and step-up of DC link voltage VD applied between the pair of DC terminals T13, T14 while switching therebetween according to battery voltage VB. In this case, bidirectional chopper 7 causes switching element Q2 to perform the switching operation and fixes switching element Q1 in the OFF state. When the current flow rate of switching element Q2 is α2, the relationship of Equation (1) above is established between DC link voltage VD, which is the input voltage of bidirectional chopper 7, and battery voltage VB, which is the output voltage of bidirectional chopper 7. As indicated by Equation (1), DC link voltage VD is stepped down when α2<0.5, and DC link voltage VD is stepped up when α2>0.5.

When discharging battery 13, bidirectional chopper 7 according to the second configuration example performs step-down and step-up of battery voltage VB applied between the pair of DC terminals T11, T12 while switching therebetween according to battery voltage VB. In this case, bidirectional chopper 7 causes switching element Q1 to perform the switching operation and fixes switching element Q2 in the OFF state. When the current flow rate of switching element Q1 is α1, the relationship of Equation (2) above is established between battery voltage VB, which is the input voltage of bidirectional chopper 7, and DC link voltage VD, which is the output voltage of bidirectional chopper 7. As indicated by Equation (2), battery voltage VB is stepped down when α1<0.5, and battery voltage VB is stepped up when α1>0.5.

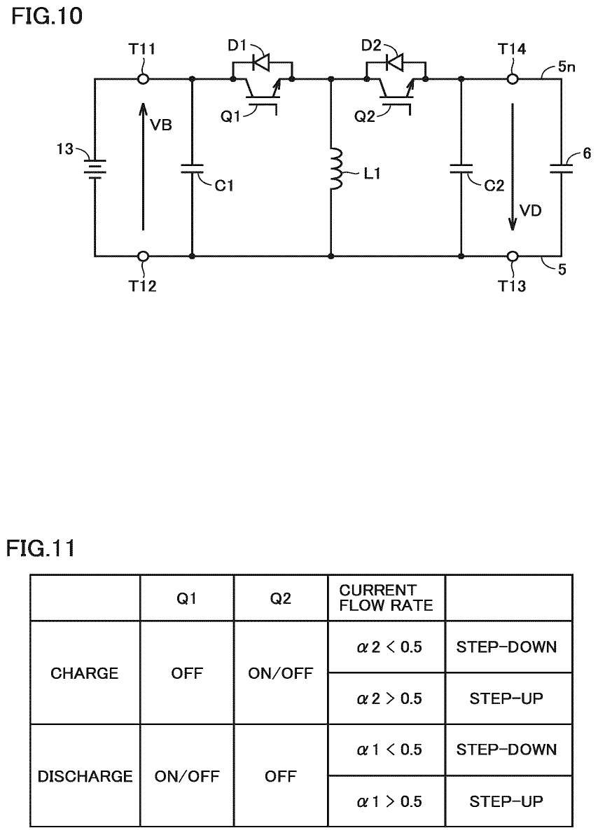

FIG. 11 illustrates an operation of bidirectional chopper 7 according to the second configuration example. As shown in FIG. 11, step-down and step-up of DC link voltage VD can be switched according to current flow rate α2 of switching element Q2. Step-down and step-up of DC link voltage VD can be switched according to current flow rate α1 of switching element Q1.

During normal operation of AC power supply 12, when VB<VD, controller 10 sets such that current flow rate α2 of switching element Q2<0.5, thereby controlling bidirectional chopper 7 to step down DC link voltage VD and output DC link voltage VD to battery 13 (first step-down operation). When VB>VD, controller 10 sets such that α2>0.5, thereby controlling bidirectional chopper 7 to step up DC link voltage VD and output DC link voltage VD to battery 13 (first step-up operation).

During a power failure of AC power supply 12, when VB>VD, controller 10 sets switching element Q1 such that current flow rate α1<0.5, thereby controlling bidirectional chopper 7 to step down battery voltage VB and output battery voltage VB to DC link 5 (second step-down operation). When VB<VD, controller 10 sets such that α1>0.5, thereby controlling bidirectional chopper 7 to step up battery voltage VB and output battery voltage VB to DC link 5 (second step-up operation).

### Third Configuration Example

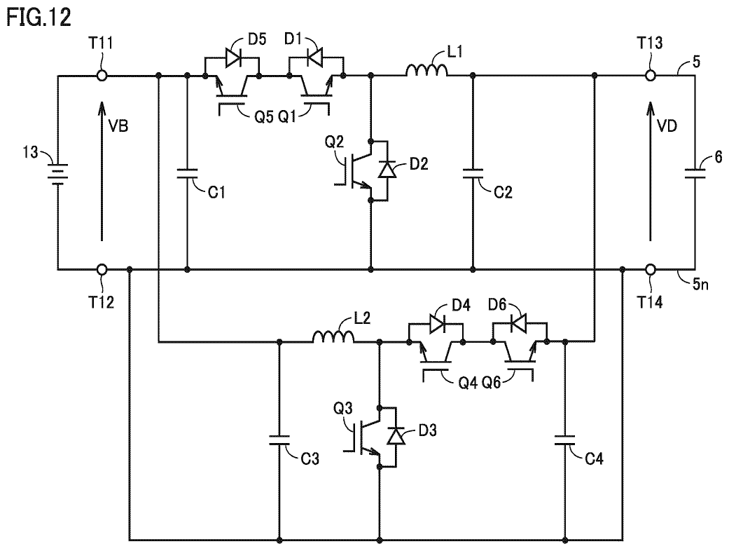

FIG. 12 is a circuit diagram showing a third configuration example of bidirectional chopper 7. As shown in FIG. 12, bidirectional chopper 7 according to the third configuration example includes the pair of DC terminals T11, T12, the pair of DC terminals T13, T14, switching elements Q1 to Q6, diodes D1 to D6, capacitors C1 to C4, and reactors L1, L2. IGBTs are used as switching elements Q1 to Q6 in FIG. 12, but any semiconductor elements such as MOSFETs can be used.

The pair of DC terminals T11, T12 are connected to battery 13. DC terminal T11 on the positive side is connected to the positive electrode of battery 13, and DC terminal T12 on the negative side is connected to the negative electrode of battery 13. The pair of DC terminals T13, T14 are connected to DC links 5, 5n. DC terminal T13 on the positive side is connected to DC link 5 on the positive side, and DC terminal T14 on the negative side is connected to DC link 5n on the negative side.

The collector of switching element Q1 is connected to a collector of switching element Q5, and the emitter of switching element Q1 is connected to the first terminal of reactor L1. The second terminal of reactor L1 is connected to DC terminal T13 on the positive side. Switching element Q5 has an emitter connected to DC terminal T11 on the positive side. The collector of switching element Q2 is connected to the emitter of switching element Q1 and the first terminal of reactor L1, and the emitter of switching element Q2 is connected to DC terminals T12, T14 on the negative side. Diodes D1, D2, D5 are connected in anti-parallel to switching elements Q1, Q2, Q5, respectively. Capacitor C1 is connected between DC terminal T11 on the positive side and DC terminal T12 on the negative side. Capacitor C2 is connected between DC terminal T13 on the positive side and DC terminal T14 on the negative side.

The first terminal of reactor L2 is connected to DC terminal T11 on the positive side, and the second terminal of reactor L2 is connected to an emitter of switching element Q4. Switching element Q4 has a collector connected to a collector of switching element Q6. Switching element Q6 has an emitter connected to DC terminal T13 on the positive side. Switching element Q3 has a collector connected to the emitter of switching element Q4 and the second terminal of reactor L2, and an emitter connected to DC terminals T12, T14 on the negative side. Diodes D3, D4, D6 are connected in anti-parallel to switching elements Q3, Q4, Q6, respectively. Capacitor C3 is connected between DC terminal T11 on the positive side and DC terminal T12 on the negative side. Capacitor C4 is connected between DC terminal T13 on the positive side and DC terminal T14 on the negative side.

In the third configuration example, switching elements Q1, Q2, Q5, diodes D1, D2, D5, reactor L1, and capacitors C1, C2 constitute a “first bidirectional chopper”. The first bidirectional chopper is configured to bidirectionally exchange power when VB>VD.

Specifically, the first bidirectional chopper operates as a step-down chopper that steps down battery voltage VB when battery voltage VB is the input voltage and DC link voltage VD is the output voltage. At this time, electric power flows from battery 13 to DC links 5, 5n, and battery 13 is discharged. The relationship of the following Equation (3) is established between battery voltage VB and DC link voltage VD, where α1 is the current flow rate of switching element Q1, and 0<α1<1.

$$VD = VB \times α 1 \qquad ( 3 )$$

On the other hand, when DC link voltage VD is the input voltage and battery voltage VB is the output voltage, the first bidirectional chopper operates as a step-up chopper that steps up DC link voltage VD. At this time, electric power flows from DC links 5, 5n to battery 13, so that battery 13 is charged. The relationship of the following Equation (4) is established between battery voltage VB and DC link voltage VD, where α2 is the current flow rate of switching element Q2, and 0<α2<1.

$$VB = VD \times 1 / ( 1 - α 2 ) \qquad ( 4 )$$

In the third configuration example, switching elements Q3, Q4, Q6, diodes D3, D4, D6, reactor L2, and capacitors C3, C4 constitute a “second bidirectional chopper”. The second bidirectional chopper is configured to bidirectionally exchange electric power when VB<VD.

Specifically, the second bidirectional chopper operates as a step-up chopper that steps up battery voltage VB when battery voltage VB is the input voltage and DC link voltage VD is the output voltage. At this time, electric power flows from battery 13 to DC links 5, 5n, so that battery 13 is discharged. The relationship of the following Equation (5) is established between battery voltage VB and DC link voltage VD, where α3 is the current flow rate of switching element Q3, and 0<α3<1.

$$VD = VB \times 1 / ( 1 - α 3 ) \qquad ( 5 )$$

On the other hand, when DC link voltage VD is the input voltage and battery voltage VB is the output voltage, the second bidirectional chopper operates as a step-down chopper that steps down DC link voltage VD. At this time, electric power flows from DC links 5, 5n to battery 13, so that battery 13 is charged. The relationship of the following Equation (6) is established between battery voltage VB and DC link voltage VD, where α4 is the current flow rate of switching element Q4, and 0<α4<1.

$$VB = VD \times α 4 \qquad ( 6 )$$

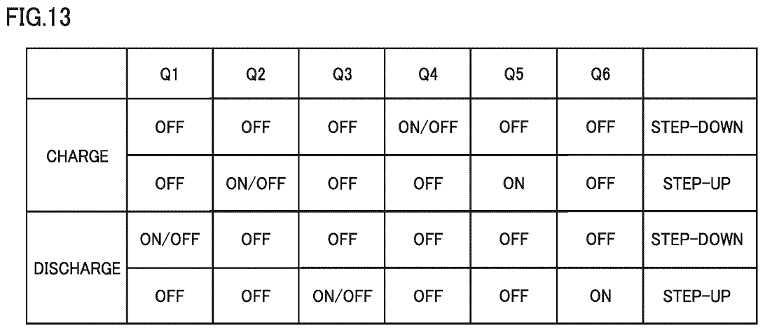

FIG. 13 illustrates an operation of bidirectional chopper 7 according to the third configuration example. As shown in FIG. 13, when battery 13 is charged, step-down and step-up of DC link voltage VD can be switched according to current flow rate α2 of switching element Q2 and current flow rate α4 of switching element Q4. Specifically, DC link voltage VD is stepped down according to current flow rate α4 of switching element Q4, and DC link voltage VD is stepped up according to current flow rate α2 of switching element Q2. In step-down of DC link voltage VD, switching element Q5 is turned off to prevent a current from flowing from DC links 5, 5n through reactor L1 into battery 13. In step-up of DC link voltage VD, switching element Q5 is turned on so as not to interfere with the step-up operation of the first bidirectional chopper.

When battery 13 is discharged, step-down and step-up of battery voltage VB can be switched according to current flow rate α1 of switching element Q1 and current flow rate α3 of switching element Q3. Specifically, battery voltage VB is stepped down according to current flow rate α1 of switching element Q1, and battery voltage VB is stepped up according to current flow rate α3 of switching element Q3. In step-down of battery voltage VB, switching element Q6 is turned off to prevent a current from flowing from battery 13 through reactor L2 into DC links 5, 5n. In step-up of battery voltage VB, switching element Q6 is turned on so as not to interfere with the step-up operation of the second bidirectional chopper.

During normal operation of AC power supply 12, when VB<VD, controller 10 fixes switching elements Q1 to Q3, Q5, Q6 in the OFF state and controls current flow rate α4 of switching element Q4, thereby controlling bidirectional chopper 7 to step down DC link voltage VD and output DC link voltage VD to battery 13 (first step-down operation). When VB>VD, controller 10 fixes switching elements Q1, Q3, Q4, Q6 in the OFF state and fixes switching element Q5 in the ON state and controls current flow rate α2 of switching element Q2, thereby controlling bidirectional chopper 7 to step up DC link voltage VD and output DC link voltage VD to battery 13 (first step-up operation).

During a power failure of AC power supply 12, when VB>VD, controller 10 fixes switching elements Q2 to Q6 in the OFF state and controls current flow rate α1 of switching element Q1, thereby controlling bidirectional chopper 7 to step down battery voltage VB and output battery voltage VB to DC link 5 (second step-down operation). When VB<VD, controller 10 fixes switching elements Q1, Q2, Q4, Q5 in the OFF state, fixes switching element Q6 in the ON state, and controls current flow rate α3 of switching element Q3, thereby controlling bidirectional chopper 7 to step up battery voltage VB and output battery voltage VB to DC link 5 (second step-up operation).

Although the embodiment above has described the operation of bidirectional chopper 7 in the case where the relationship V1<VD<V2 is established among charge termination voltage V and discharge termination voltage V1 of battery 13, and DC link voltage VD, in the case where the relationship V1<V2<VD is satisfied, when charging battery 13, bidirectional choppers 7 according to the first to third configuration examples only perform the step-down operation of stepping down DC link voltage VD, because VB<VD at all times. Also, when discharging battery 13, bidirectional choppers 7 according to the first to third configuration examples only perform the step-up operation of stepping up battery voltage VB, because VB<VD at all times.

As described above, the uninterruptible power supply device according to Embodiment 1 can work with both batteries whose charge termination voltage V2 is greater than DC link voltage VD and batteries whose charge termination voltage V2 is smaller than DC link voltage VD. Thus, compared with a conventional uninterruptible power supply device, the operating voltage range of a battery that can be connected to an uninterruptible power supply device is expanded, increasing the types of batteries that can be used. As a result, combinations of uninterruptible power supply devices and batteries that are optimal in terms of the scale and cost of the devices can be proposed to users of uninterruptible power supply devices.

### Embodiment 2

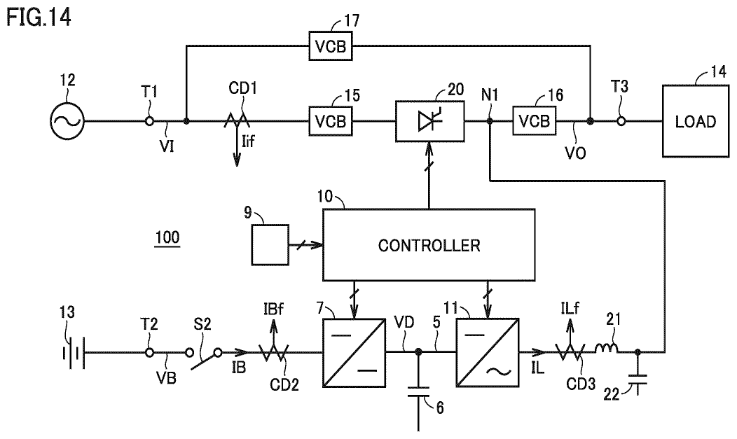

Embodiment 1 above has described uninterruptible power supply device 100 including a power converter (converter 4, inverter 8, bidirectional chopper 7) connected between AC power supply 12 and load 14. However, uninterruptible power supply device 100 according to the present disclosure needs to include only at least bidirectional chopper 7 that exchanges electric power between battery 13 and DC link 5. For example, uninterruptible power supply device 100 may have a configuration shown in FIG. 14.

FIG. 14 is a circuit block diagram showing a configuration of an uninterruptible power supply device according to Embodiment 2. Uninterruptible power supply device 100 according to Embodiment 2 receives a three-phase AC voltage from AC power supply 12 and supplies the three-phase AC voltage to load 14, but for simplicity of the drawing and description, only the circuit for one phase is shown in FIG. 14.

As shown in FIG. 14, uninterruptible power supply device 100 according to Embodiment 2 includes input terminal T1, DC terminal T2, output terminal T3, vacuum circuit breakers (VCBs) 15 to 17, a high speed switch (HSS) 20, a bidirectional converter 11, bidirectional chopper 7, reactor 21, capacitors 6, 22, current detectors CD1 to CD3, and controller 10. Uninterruptible power supply device 100 according to Embodiment 2 is also referred to as a multiple power compensator.

VCB 15, HSS 20, and VCB 16 are connected in series between input terminal T1 and output terminal T3. VCB 15 and VCB 16 are turned on during normal operation of uninterruptible power supply device 100 and are turned off during maintenance of HSS 20 (during maintenance bypass power feeding).

HSS 20 is constituted of, for example, a semiconductor switching element and is controlled by controller 10. HSS 20 is turned on during normal operation of AC power supply 12 and is turned off during a power failure of AC power supply 12.

VCB 17 is connected between input terminal T1 and output terminal T3. VCB 17 is turned off during normal operation of uninterruptible power supply device 100 and is turned on, for example, during maintenance bypass power feeding. When VCB 17 is turned on, AC input voltage V1 is supplied from AC power supply 12 to load 14 through VCB 17, and load 14 is operated.

Bidirectional converter 11 has an AC terminal connected to a node N1 between HSS 20 and VCB 16 via reactor 21. Bidirectional converter 11 has a DC terminal connected to DC link 5. Bidirectional converter 11 is a well-known one including a plurality of switching elements and a plurality of diodes, and is subjected to, for example, pulse width modulation (PWM) control by controller 10. As each switching element included in bidirectional converter 11 is turned on and off at a predetermined switching frequency, AC power can be converted into to DC power, and conversely, DC power can be converted into AC power.

Reactor 21 and capacitor 22 constitute an AC filter. The AC filter is a low-pass filter, which allows a current of commercial frequency to pass therethrough and interrupts a current of switching frequency generated in bidirectional converter 11. In other words, the AC filter converts the output voltage of bidirectional converter 11 into a sinusoidal AC voltage.

Capacitor 6 is connected to DC link 5, and smooths and stabilizes DC link voltage VD. The instantaneous value of DC link voltage VD is detected by controller 10.

Bidirectional chopper 7 is connected between DC link 5 and DC terminal T2. Bidirectional chopper 7 is controlled by controller 10 and exchanges DC power between DC link 5 and battery 13. Bidirectional chopper 7 is configured to selectively perform the charging operation of storing DC power of DC link 5 in battery 13 and the discharging operation of supplying the DC power stored in battery 13 to DC link 5. Any of the bidirectional choppers according to the first to third configuration examples described above can be applied to bidirectional chopper 7.

Current detector CD1 detects AC input current Ii flowing through HSS 20 and provides signal lif indicating a value of the detection to controller 10. Current detector CD2 detects DC current IB flowing between battery 13 and bidirectional chopper 7 and provides signal IBf indicating a value of the detection to controller 10. Current detector CD3 detects an AC output current IL flowing through reactor 21 and provides a signal ILf, which indicates a value of the detection, to controller 10.

Controller 10 controls the entire uninterruptible power supply device 100 based on, for example, AC voltages V1, V0, DC voltages VD, VB, and output signals Iif, IBf, IOf of current detectors CD1 to CD3.

In uninterruptible power supply device 100 shown in FIG. 14, during normal operation of AC power supply 12, HSS 20 is turned on, and AC power is supplied from AC power supply 12 through VCB 15, HSS 20, and VCB 16 to load 14, so that load 14 is driven.

AC power is supplied from AC power supply 12 through VCB 15 and HSS 20 to bidirectional converter 11, and the AC power is converted into DC power by bidirectional converter 11 and is supplied to DC link 5. This DC power is stored in battery 13 by bidirectional chopper 7. At this time, controller 10 controls bidirectional converter 11 such that DC link voltage VD becomes equal to reference DC voltage VDR. Controller 10 also controls bidirectional chopper 7 such that battery voltage VB becomes equals to reference DC voltage VBR.

When there is the relationship V1<VD<V2 among discharge termination voltage V1 and charge termination voltage V2 of battery 13, and DC link voltage VD, bidirectional chopper 7 performs the step-down operation of stepping down DC link voltage VD, which is the input voltage, and the step-up operation of stepping up DC link voltage VD while switching therebetween according to battery voltage VB. As described in Embodiment 1, during the period in which battery voltage VB is lower than DC link voltage VD, bidirectional chopper 7 performs the step-down operation. During the period in which battery voltage VB is higher than DC link voltage VD, bidirectional chopper 7 performs the step-up operation.

When a power failure of AC power supply 12 occurs, HSS 20 is instantly turned off to electrically disconnect AC power supply 12 from load 14. At the same time, DC power of battery 13 is supplied to DC link 5 by bidirectional chopper 7. The DC power is then converted into AC power by bidirectional converter 11 and is supplied to load 14, and load 14 continues to operate. Controller 10 controls bidirectional chopper 7 such that DC link voltage VD becomes equal to reference DC voltage VDR. When battery voltage VB falls due to discharging of battery 13 and reaches discharge termination voltage V1, controller 10 stops discharging of battery 13 by stopping bidirectional chopper 7.

When there is the relationship V1<VD<V2, bidirectional chopper 7 performs the step-down operation of stepping down battery voltage VB, which is the input voltage, and the step-up operation of stepping up battery voltage VB while switching therebetween according to battery voltage VB. As described in Embodiment 1, during the period in which battery voltage VB is higher than DC link voltage VD, bidirectional chopper 7 performs the step-down operation. During the period in which battery voltage VB is lower than DC link voltage VD, bidirectional chopper 7 performs the step-up operation.

Consequently, the uninterruptible power supply device according to Embodiment 2 also achieves the same effects as those of the uninterruptible power supply device according to Embodiment 1.

It should be understood that the embodiments disclosed herein are illustrative and non-restrictive in every respect. The scope of the present disclosure is defined by the scope of the claims, rather than the description above, and is intended to include any modifications within the meaning and scope equivalent to the scope of the claims.

### REFERENCE SIGNS LIST

4 converter; 5, 5n DC link; 6, 22, C₁ to C₄ capacitor; 7 bidirectional chopper; 8 inverter; 9 operation unit; 10 controller; 11 bidirectional converter; 12 AC power supply; 13 battery; 14 load; 15 to 17 VCB; 20 HSS; 21, L1, L2 reactor; 100 uninterruptible power supply device; 102 CPU; 104 memory; 106 I/O circuit; 108 bus; T1 input terminal; T2, T11, T12, T13, T14 DC terminal; T3 output terminal; S1 to S3 switch; VB battery voltage; VD DC link voltage; CD1 to CD3 current detector; Q1 to Q6 switching element; D1 to D6 diode; S1 to S3 switch.

1. An uninterruptible power supply device connected between an alternate-current (AC) power supply and a load, the uninterruptible power supply device comprising:
a converter that converts AC power supplied from the AC power supply into direct-current (DC) power;
an inverter that converts the DC power into AC power and supplies the AC power to the load;
a DC link connected between the converter and the inverter for inputting the DC power to the inverter; and
a bidirectional chopper that performs DC voltage conversion between the DC link and a power storage device, wherein
the bidirectional chopper is configured to perform a charging operation of storing the DC power of the DC link in the power storage device during normal operation of the AC power supply, and
when a charge termination voltage of the power storage device is higher than a DC link voltage of the DC link and a discharge termination voltage of the power storage device is lower than the DC link voltage, the bidirectional chopper performs, when performing the charging operation, a first step-down operation of stepping down the DC link voltage and a first step-up operation of stepping up the DC link voltage while switching therebetween in accordance with a voltage of the power storage device.

2. The uninterruptible power supply device according to claim 1, wherein the bidirectional chopper
performs the first step-down operation when the voltage of the power storage device is lower than the DC link voltage, and
performs the first step-up operation when the voltage of the power storage device is higher than the DC link voltage.

3. The uninterruptible power supply device according to claim 1, wherein
the bidirectional chopper is configured to perform a discharging operation of supplying the DC power stored in the power storage device to the DC link during a power failure of the AC power supply, and
when the charge termination voltage of the power storage device is higher than the DC link voltage and the discharge termination voltage is lower than the DC link voltage, the bidirectional chopper performs, when performing the discharging operation, a second step-down operation of stepping down the voltage of the power storage device and a second step-up operation of stepping up the voltage of the power storage device while switching therebetween in accordance with the voltage of the power storage device.

4. The uninterruptible power supply device according to claim 3, wherein the bidirectional chopper
performs the second step-down operation when the voltage of the power storage device is higher than the DC link voltage, and
performs the second step-up operation when the voltage of the power storage device is lower than the DC link voltage.

5. The uninterruptible power supply device according to claim 3, wherein when the charge termination voltage of the power storage device is lower than the DC link voltage, the bidirectional chopper
performs the first step-down operation when performing the charging operation, and
performs the second step-up operation when performing the discharging operation.

6. The uninterruptible power supply device according to claim 3, wherein
the bidirectional chopper includes
a first switching element that is turned on and off when performing the discharging operation and is turned off when performing the charging operation, and
a second switching element that is turned on and off when performing the charging operation and is turned on and off when performing the discharging operation, and
the bidirectional chopper
controls a second current flow rate of the second switching element to perform the first step-down operation and the first step-up operation while switching therebetween in accordance with the voltage of the power storage device, and
controls a first current flow rate of the first switching element to perform the second step-down operation and the second step-up operation while switching therebetween in accordance with the voltage of the power storage device.

7. The uninterruptible power supply device according to claim 3, wherein the bidirectional chopper includes
a first bidirectional chopper configured to perform the first step-up operation and the second step-down operation while switching therebetween when the voltage of the power storage device is higher than the DC link voltage, and
a second bidirectional chopper configured to perform the first step-down operation and the second step-up operation while switching therebetween when the voltage of the power storage device is lower than the DC link voltage.

8. The uninterruptible power supply device according to claim 2, wherein
the bidirectional chopper is configured to perform a discharging operation of supplying the DC power stored in the power storage device to the DC link during a power failure of the AC power supply, and
when the charge termination voltage of the power storage device is higher than the DC link voltage and the discharge termination voltage is lower than the DC link voltage, the bidirectional chopper performs, when performing the discharging operation, a second step-down operation of stepping down the voltage of the power storage device and a second step-up operation of stepping up the voltage of the power storage device while switching therebetween in accordance with the voltage of the power storage device.
